(19) United States
(12) Patent Application Publication
(10) Pub. No.: US 2026/0365864 A1
(43) Pub. Date: Nov. 19, 2026

(54) UV COATINGS FOR MONOWEB FILMS AND LABELS

(71) Applicant: Sun Chemical Corporation, Parsippany, NJ (US)

(72) Inventors: Glenn WEBSTER, Northlake, IL (US); Mackensey FAGAN, Northlake, IL (US)

(73) Assignee: Sun Chemical Corporation, Parsippany, NJ (US)

(21) Appl. No.: 19/132,207

(22) PCT Filed: Nov. 22, 2023
(86) PCT No.: PCT/US2023/080972

§ 371 Date: May 22, 2025

Related U.S. Application Data
(60) Provisional application No. 63/385,652, filed on Dec. 1, 2022.

(51) Int. Cl. C09D 11/101; C08K 9/00; C09D 7/63; C09D 7/65; C09D 11/102; C09D 133/08

(52) U.S. Cl. CPC C09D 11/101; C08K 9/00; C09D 7/63; C09D 7/65; C09D 11/102; C09D 133/08

(57) ABSTRACT

The present invention provides a method for preparing a monoweb label comprising: (a) providing a substrate; (b) depositing an energy curable coating composition onto the substrate; and (c) curing the deposited coating at about 30 to about 100 mJ/cm² of ultraviolet radiation; wherein a multi-layer lamination processing is not required for preparing the label. The energy curable coating composition comprises: about 50 wt % to about 99 wt % of one or more acrylates, of which at least about 50 wt % of the total weight of acrylates are selected from the group consisting of pentaerythritol (5EO) tetraacrylate, propoxylated glycerol triacrylate, trimethylolpropane triacrylate, dipentaerythritol pentaacrylate, tripropyleneglycol diacrylate and blends thereof; about 1 wt % to about 20 wt % of one or more photoinitiators, comprising Norrish Type I photoinitiators and Norrish Type II photoinitiators; and about 5 wt % to about 20 wt % of one or more amine synergists.

### CROSS REFERENCE TO RELATED APPLICATION

The present application claims priority to U.S. Provisional Application No. 63/385,652, filed Dec. 1, 2022, which is incorporated herein in its entirety.

### FIELD OF THE INVENTION

The present invention relates to ultraviolet radiation curable coatings for monoweb films and labels.

### BACKGROUND OF THE INVENTION

In the packaging industry, high gloss multilayer laminate labels and films provide durability and protection and add certain aesthetic properties to underlying printing inks, which provide informative and decorative graphics, when sealed between layers of different combinations of polymer, or paper-based, or metalized substrates, resulting in a layered structure.

Radiation-cured, laminated flexible packaging material are known in the art, such as those disclosed in U.S. Pat. No. 7,294,658B2. However, such layered structures can be difficult to recycle due to the need to separate the different polymers and material layers in the structure. Thus, there is a need for providing labels that can be more readily recycled without having to separate the various layers that are present in a laminate structure.

The present application addresses this need by describing energy curable (EC) coatings and a method of using them on monoweb films comprised of an easily recyclable polyolefin core to produce monoweb labels having the required end use performance properties for durability, aesthetics, label converting, label application, transport and storage without the need for lamination. The replacement of multi-layer lamination structures with monoweb labels leads to much easier recycling, as there is no longer a need to separate the various layers of the laminated structure prior to introducing the materials into the recycle stream.

Another consideration for use of printed labels on items such as food packaging is the migration of unwanted and/or toxic compounds into the product. For example, photoinitiators (PI's) can undergo photolytic breakdown to unexpected by-products and benzene is formed at trace levels as a photolytic decomposition product of most UV-cured materials, originating presumably from aromatic ring precursors in the PI's or other ink, varnish, adhesive, or substrate components. Scarsella et al. “Identification and Migration Studies of Photolytic Decomposition Products of UV-Photoinitiators in Food Packaging,” Molecules 2019, 24(19), 3592; doi:10.3390/molecules24193592. Concentration of benzene production is directly proportional to the amount of UV light energy to which the material is exposed during the UV-cure process. Id. The present application also addresses the need for reduction of migratable photoinitiator by-products during UV cure.

Citation or identification of any document in this application is not an admission that such represents prior art to the present invention.

### SUMMARY OF THE INVENTION

In one aspect of the invention, a method for preparing a monoweb label is provided comprising:
(a) providing a substrate;
(b) depositing an energy curable coating composition onto the substrate, wherein the energy curable coating composition comprises:
   i. about 50 wt % to about 99 wt % of one or more acrylates, based on the total weight of the composition, of which at least about 50 wt % of the total weight of acrylates are selected from the group consisting of pentaerythritol (5EO) tetraacrylate, propoxylated glycerol triacrylate, trimethylolpropane triacrylate, dipentaerythritol pentaacrylate, tripropyleneglycol diacrylate and blends thereof;
   ii. about 1 wt % to about 20 wt % of one or more photoinitiators, comprising Norrish Type I photoinitiators and Norrish Type II photoinitiators, based on the total weight of the composition; and
   iii. about 5 wt % to about 20 wt % of one or more amine synergists, based on the total weight of the composition; and
(c) curing the deposited coating at about 30 to about 100 mJ/cm² of ultraviolet radiation comprising ultraviolet A, ultraviolet B and ultraviolet C radiations,
(d) wherein a multi-layer lamination processing is not required for preparing the label.

In another aspect of the invention, a monoweb label prepared by the methods of the invention is provided.

In yet another aspect of the invention, a method of providing a readily recycled label that does not require separation of layers or lamination is provided comprising preparing a monoweb label according to methods of the invention.

In a further aspect of the invention, the coatings are formulated to minimize the amount of extractable components, such as extractable benzene.

### DETAILED DESCRIPTION

The present application describes EC (energy curable) coatings and a method of their use to replace multi-layer laminated label or packaging film structures. Advantageously, the EC coating would have low residual and photolytic benzene generation, low UV-cure energy dose requirement, and meet the end-use requirements for the applications in which they are used.

It is to be understood that the foregoing general description and the following detailed description are exemplary and explanatory only, and are not restrictive of any subject matter claimed.

Headings are used solely for organizational purposes, and are not intended to limit the invention in any way.

Unless otherwise defined, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety for any purpose. Although any methods and materials similar or equivalent to those described herein can be used in the practice or testing of the present invention, the preferred methods are described.

### DEFINITIONS

In this application, the use of the singular includes the plural unless specifically stated otherwise. As used herein, the singular forms “a,” “an” and “the” are intended to include the plural forms as well, unless the context clearly indicates otherwise.

In this application, the use of “or” means “and/or” unless stated otherwise. Also, when it is clear from the context in which it is used, “and” may be interpreted as “or,” such as in a list of alternatives where it is not possible for all to be true or present at once.

As used herein, the terms “comprises” and/or “comprising” specify the presence of the stated features, integers, steps, operations, elements, and/or components, but do not preclude the presence or addition of one or more other features, integers, steps, operations, elements, components, and/or groups thereof. Furthermore, to the extent that the terms “includes,” “having,” “has,” “with,” “composed,” “comprised” or variants thereof are used in either the detailed description or the claims, such terms are intended to be inclusive in a manner similar to the term “comprising.”

When the terms “consist of”, “consists of” or “consisting of” is used in the body of a claim, the claim term set off with “consist of”, “consists of” and/or “consisting of” is limited to the elements recited immediately following “consist of”, “consists of” and/or “consisting of”, and is closed to unrecited elements related to that particular claim term. The term “combinations thereof”, when included in the listing of the recited elements that follow “consist of”, “consists of” and/or “consisting of” means a combination of only two or more of the elements recited.

As used herein, ranges and amounts can be expressed as “about” a particular value or range. “About” is intended to also include the exact amount. Hence “about 5 percent” means “about 5 percent” and also “5 percent.” “About” means within typical experimental error for the application or purpose intended. The term “about” as used herein means within 5%, and more preferably within 1%, of a given value or range. For example, “about 3.7%” means from 3.5 to 3.9%, preferably from 3.66 to 3.74%. When the term “about” is associated with a range of values, e.g., “about X % to Y %”, the term “about” is intended to modify both the lower (X) and upper (Y) values of the recited range. For example, “about 20% to 40%” is equivalent to “about 20% to about 40%”.

It is to be understood that wherein a numerical range is recited, it includes the end points, all values within that range, and all narrower ranges within that range, whether specifically recited or not.

Throughout this disclosure, all parts and percentages are by weight (wt % or mass % based on the total weight) and all temperatures are in °C unless otherwise indicated.

As used herein, “substrate” means any surface or object to which an ink or coating can be applied. Substrates include, but are not limited to, cellulose-based substrates, paper, paperboard, fabric (e.g. cotton), leather, textiles, felt, concrete, masonry, stone, plastic, plastic or polymer film, spunbond non-woven fabrics (e.g. consisting of polypropylene, polyester, and the like) glass, ceramic, metal, wood, composites, combinations thereof, and the like. Substrates may have one or more layers of metals or metal oxides, or other inorganic materials. Particularly preferred are non-woven substrates.

As used herein, the term “article” or “articles” means a substrate or product of manufacture. Examples of articles include, but are not limited to: substrates such as cellulose-based substrates, paper, paperboard, plastic, plastic or polymer film, glass, ceramic, metal, composites, and the like; and products of manufacture such as publications (e.g. brochures), labels, and packaging materials (e.g. cardboard sheet or corrugated board), containers (e.g. bottles, cans), a polyolefin (e.g. polyethylene or polypropylene), a polyester (e.g. polyethylene terephthalate), a metalized foil (e.g. laminated aluminum foil), metalized polyester, a metal container, and the like.

As used herein, “inks and coatings,” “inks,” and “coatings” are used interchangeably, and refer to compositions of the invention, or, when specified compositions found in the prior art (comparative). Inks and coatings typically contain resins, solvent, and, optionally, colorants. Coatings are often thought of as being colorless or clear, while inks typically include a colorant.

As used herein, “energy-curing” refers to the cure achieved under exposure to various electromagnetic radiation sources producing an actinic effect. Such sources include but are not limited to, electron-beam, UV-light, visible-light, IR, or microwave. Where the compositions are cured under the action of UV light, then non-limiting UV sources such as the following can be used: low pressure mercury bulbs, medium pressure mercury bulbs, a xenon bulb, excimer lamps, a carbon arc lamp, a metal halide bulb, a UV-LED lamp or sunlight. It should be appreciated by those skilled in the art that any UV light source may be used to cure compositions prepared according to the current invention. Compositions of the current invention are especially suited for use in compositions curable under the action of UV light and/or electron-beam.

As used herein, “energy-curable” refers to a composition that can be cured by exposure to one or more types of actinic radiation. Compositions of the current invention are especially suited for use in compositions curable under the action of UV light and/or electron-beam.

As used herein, “(meth)acrylate” and “(meth)acrylic acid” include both acrylate and methacrylate, and acrylic and methacrylic acid.

As used herein, “monofunctional” means having one functional group.

As used herein, “multifunctional” means having two or more functional groups. A multifunctional monomer, for example, can be di-functional, tri-functional, tetra-functional, or have a higher number of functional groups. The two or more functional groups can be the same or different.

As used herein, “monomer” refers to a small molecule having one or more functional groups. Monomers react with other monomers, either the same or different, to form monomer chains (oligomers and/or polymers). Each monomer in a chain is a monomer repeating unit. A monomer is the smallest unit that makes up an oligomer or a polymer. A monomer is a low molecular weight molecule, usually less than or equal to 100 Daltons weight average molecular weight (Mw).

As used herein, “oligomer” refers to a chain of a few monomer repeating units. Oligomers are a few to several monomer units long chains, and have a mid-range weight average molecular weight of about 100 Daltons to about 10,000 Daltons.

As used herein, “polymer” refers to a large molecule, containing multiple monomer and/or oligomer repeating units. Polymers are high molecular weight molecules, having a weight average molecular weight of greater than about 10,000 Daltons.

As used herein, “coefficient of friction” or “CoF” is the ratio of the frictional force resisting movement of the surface being tested to the force applied normal to that surface. “Kinetic CoF” is the ratio of the force resisting motion of the surface to the normal force once the motion is in progress. “Static CoF” refers to the ratio of the force resisting initial motion of the surface to the normal force.

As used herein the “wt % of one or more acrylates” and “total weight of the acrylates” excludes any wt %, weight or amounts attributable to acrylate amine synergists, acrylate photoinitiators, or acrylate EC additives.

### Energy Curable Coatings and Methods of Use Thereof

The labels, films and packaging produced by employing the methods of the invention are easier to recycle because the need to laminate using a second dissimilar substrate is eliminated. Dissimilar substrate and lamination films such as polyester and low density polyethylene for example, make recycling more difficult or impossible using locally available industrial methods.

In the methods of the invention, use of suitable UV polymerizable monomers and oligomers, and UV photoinitiators allows low energy curing and minimizes the generation of undesirable molecular fragments (e.g., benzene) as by-products after UV-cure photolysis and polymerization. The coatings of the invention have the capability to cure efficiently using a minimum UV light energy dose, producing coated labels and packaging with low CoF as required, for example, in printing beverage bottle labels experiencing face-to-face label contact in filling, packaging and transport of bottles and containers to their destination. The coatings of the invention are used to protect printing underneath instead of using a laminated second substrate to protect the printing. The coatings may also be described as a top coat

Advantageously, in some embodiments of the invention, the coatings may consist essentially of ethylenically unsaturated acrylate monomers and/or oligomers, and alpha-cleavage Norrish Type I and hydrogen-abstraction Norrish Type II photoinitiators, amine synergists, and performance additives such as co-polymerizable amines, inorganic and organic fillers, surfactants, and waxes.

In some embodiments, certain co-polymerizable amines, PIs and amine synergists are found to be particularly suitable. Such ingredients include IGM Resins, Omnirad 2959 (1-[4-(2-hydroxyethoxyl)-phenyl]-2-hydroxy-2-methylpropanone), Omnipol BP (di-ester of carboxymethoxybenzophenone and polytetramethyleneglycol 250), Allnex Ebecryl P39 (polymeric benzophenone derivative diluted with 25% of EBECRYL® LEO 10501(trifunctional diluting oligomer)), and GM Resins Photomer 4250 (reaction mass of trimethylolpropane triacrylate and hexamethyleneimine/1H-Azepine-1-propanoic acid, hexahydro-, 2,2-bis[[(1-oxo-2-propen-1-yl)oxy]methyl]butyl ester), Allnex Ebecryl P115 (co-polymerizable amine; adduct of Diethylamine and Tripropylene Glycol Diacrylate), and Rahn Genomer 5161 (oligoamine, acrylate amine synergist; propylidynetrimethanol, ethoxylated, esters with acrylic acid, reaction products with diethylamine).

### Substrate

Suitable substrates include printed substrates, such as a polyolefin packaging and label film on a printing press. In some embodiments, the substrate is made of recyclable polyolefin.

### Acrylates

While any ethylenically unsaturated monomers and oligomers may be used in the energy curable coating compositions of the invention, UV polymerizable acrylates monomers and oligomers are primarily used as the energy curable compounds in the coating methods of the inventions.

Acrylates selected from the group consisting of pentaerythritol (5EO) tetraacrylate, propoxylated glycerol triacrylate, trimethylolpropane triacrylate, dipentaerythritol pentaacrylate, tripropyleneglycol diacrylate and blends thereof are believed to facilitate low energy curing and comprise at least about 50 wt % of the total weight of acrylates in the coating composition, such as at least about 55 wt %, at least about 60 wt %, at least about 70 wt %, at least about 80 wt %, at least about 90 wt %, or at least about 99 wt %.

Acrylates selected from the group consisting of pentaerythritol (5EO) tetraacrylate, propoxylated glycerol triacrylate, trimethylolpropane triacrylate, dipentaerythritol pentaacrylate, tripropyleneglycol diacrylate and blends thereof may comprise about 50 wt % to about 99 wt % of the energy curable coating, based on the total weight of the coating, such as about 55 wt % to about 95 wt %, about 60 wt % to about 90 wt %, about 65 wt % to about 85 wt %, about 55 wt % to about 99 wt %, about 60 wt % to about 99 wt %, about 65 wt % to about 99 wt %, about 70 wt % to about 99 wt %, about 50 wt % to about 95 wt %, about 50 wt % to about 90 wt %, about 50 wt % to about 85 wt %, about 50 wt % to about 80 wt %, or about 50 wt % to about 75 wt %.

### Monomers

Examples of suitable monofunctional ethylenically unsaturated monomers include but are not limited to the following (and combinations thereof):

isobutyl acrylate; cyclohexyl acrylate; iso-octyl acrylate; n-octyl acrylate; isodecyl acrylate; iso-nonyl acrylate; octyl/decyl acrylate; lauryl acrylate; 2-propyl heptyl acrylate; tridecyl acrylate; hexadecyl acylate; stearyl acrylate; iso-stearyl acrylate; behenyl acrylate; tetrahydrofurfuryl acrylate; 4-t.butyl cyclohexyl acrylate; 3,3,5-trimethylcyclohexane acrylate; 9ethylami acrylate; dicyclopentyl acrylate; dihydrodicyclopentadienyl acrylate; dicyclopentenyloxyethyl acrylate; dicyclopentanyl acrylate; benzyl acrylate; phenoxyethyl acrylate; 2-hydroxy-3-phenoxypropyl acrylate; alkoxylated nonylphenol acrylate; cumyl phenoxyethyl acrylate; cyclic trimethylolpropane formal acrylate; 2(2-ethoxyethoxy) ethyl acrylate; polyethylene glycol monoacrylate; polypropylene glycol monoacrylate; caprolactone acrylate; ethoxylated methoxy polyethylene glycol acrylate; methoxy triethylene glycol acrylate; tripropyleneglycol monomethyl ether acrylate; diethylenglycol butyl ether acrylate; alkoxylated tetrahydrofurfuryl acrylate; ethoxylated ethyl hexyl acrylate; alkoxylated phenol acrylate; ethoxylated phenol acrylate; ethoxylated nonyl phenol acrylate; propoxylated nonyl phenol acylate; polyethylene glycol o-phenyl phenyl ether acrylate; ethoxylated p-cumyl phenol acrylate; ethoxylated nonyl phenol acrylate; alkoxylated lauryl acrylate; ethoxylated tristyrylphenol acrylate; N-(acryloyloxyethyl)hexahydrophthalimide; N-butyl 1,2 (acryloyloxy) ethyl carbamate; acryloyl oxyethyl hydrogen succinate; octoxypolyethylene glycol acrylate; octafluoropentyl acrylate; 2-isocyanato ethyl acrylate; acetoacetoxy ethyl acrylate; 2-methoxyethyl acrylate; dimethyl aminoethyl acrylate; 2-carboxyethyl acrylate; 4-hydroxy butyl acrylate.

Examples of suitable multifunctional ethylenically unsaturated monomers include but are not limited to the following (and combinations thereof):

1,3-butylene glycol diacrylate; 1,4-butanediol diacrylate; neopentyl glycol diacrylate; ethoxylated neopentyl glycol diacrylate; propoxylated neopentyl glycol diacrylate; 2-methyl-1,3-propanediyl ethoxy acrylate; 2-methyl-1,3-propanediol diacrylate; ethoxylated 2-methyl-1,3-propanediol diacrylate; 3 methyl 1,5-pentanediol diacrylate; 2-butyl-2-ethyl-1,3-propanediol diacrylate; 1,6-hexanediol diacrylate; alkoxylated hexanediol diacrylate; ethoxylated hexanediol diacrylate; propoxylated hexanediol diacrylate; 1,9-nonanediol diacrylate; 1,10 decanediol diacrylate; ethoxylated hexanediol diacrylate; alkoxylated hexanediol diacrylate; diethyleneglycol diacrylate; triethylene glycol diacrylate; tetraethylene glycol diacrylate; polyethylene glycol diacrylate; propoxylated ethylene glycol diacrylate; dipropylene glycol diacrylate; tripropyleneglycol diacrylate; polypropylene glycol diacrylate; poly (tetramethylene glycol) diacrylate; cyclohexane dimethanol diacrylate; ethoxylated cyclohexane dimethanol diacrylate; alkoxylated cyclohexane dimethanol diacrylate; polybutadiene diacrylate; hydroxypivalyl hydroxypivalate diacrylate; tricyclodecanedimethanol diacrylate; 1,4-butanediylbis[oxy(2-hydroxy-3,1-propanediyl)]diacrylate; ethoxylated bisphenol A diacrylate; propoxylated bisphenol A diacrylate; propoxylated ethoxylated bisphenol A diacrylate; ethoxylated bisphenol F diacrylate; 2-(2-Vinyloxyethoxy)ethyl acrylate; dioxane glycol diacrylate; ethoxylated glycerol triacrylate; glycerol 10ethylamino10 triacrylate; pentaerythritol triacrylate; trimethylolpropane triacrylate; caprolactone modified trimethylol propane triacrylate; ethoxylated trimethylolpropane triacrylate; propoxylated trimethylol propane triacrylate; tris (2-hydroxy ethyl) isocyanurate triacrylate; e-caprolactone modified tris (2-hydroxy ethyl) isocyanurate triacrylate; melamine acrylate oligomer; pentaerythritol tetraacrylate; ethoxylated pentaerythritol tetraacrylate; di-trimethylolpropane tetra acrylate; dipentaerythritol pentaaacrylate; dipentaerythritol hexaacrylate; ethoxylated dipentaerythritol hexaacrylate.

Equivalent methacrylate compounds are also capable of being used, although those skilled in the art will appreciate that methacrylate compounds have lower reactivity than their equivalent acrylate counterparts.

Other functional monomer classes capable of being used in part in these formulations include cyclic lactam such as N-vinyl caprolactam; N-vinyl oxazolidinone and N-vinyl pyrrolidone, and secondary or tertiary acrylamides such as acryloyl morpholine; diacetone acrylamide; N-methyl acrylamide; N-ethyl acrylamide; N-isopropyl acrylamide; N-t.butyl acrylamide; N-hexyl acrylamide; N-cyclohexyl acrylamide; N-octyl acrylamide; N-t.octyl acrylamide; N-dodecyl acrylamide; N-benzyl acrylamide; N-(hydroxymethyl)acrylamide; N-isobutoxymethyl acrylamide; N-butoxymethyl acrylamide; N,N-dimethyl acrylamide; N,N-diethyl acrylamide; N,N-propyl acrylamide; N,N-dibutyl acrylamide; N,N-dihexyl acrylamide; N,N-dimethylamino methyl acrylamide; N,N-dimethylamino ethyl acrylamide; N,N-dimethylamino propyl acrylamide; N,N-dimethylamino hexyl acrylamide; N,N-diethylamino methyl acrylamide; N,N-diethylamino ethyl acrylamide; N,N-diethylamino propyl acrylamide; N,N-dimethylamino hexyl acrylamide; and N,N′-methylenebisacrylamide.

### Oligomers

Oligomers are substances that provide the vehicle for the UV ink. They are similar to monomers, except that they have already been partially polymerized, which makes them more viscous. During curing, the monomers react with the oligomers to create chains in three dimensions. In the printing industry, mainly resins/oligomers with acrylate functionality are used to provide the necessary reactivity to enable adequate cure for modern, high-speed presses.

The main classes of suitable acrylated oligomers includes epoxy acrylates; urethanes acrylates; polyester acrylates; acrylic acrylates; hyperbranched polyester acrylates; waterborne UV polyurethane dispersions and, organic-inorganic hybrid materials.

### Photoinitiators

Free radical photoinitiators are classified into one of two main groups, depending on what type of reactive species is formed, Norrish type I and Norrish type II. Norrish type I photoinitiators are cleavage type photoinitiators, wherein actinic radiation exposure leads to hemolytic bond cleavage and generation of two reactive fragments of the photoinitiator. Norrish type II photoinitiators are hydrogen abstraction, and need a hydrogen donor to react. Synergists, such as amines, are generally used in combination with Norrish type II photoinitiators as the source of the hydrogen donor. The type II photoinitiator abstracts a hydrogen atom from the synergist, forming two radicals.

There is no restriction on the type, blend or concentration of photoinitiator used and can include any suitable type of photoinitiators, such as, but not limited to: α-hydroxyketones, acyl phosphine oxides, α-aminoketones, thioxanthones, benzophenones, phenylglyoxylates, oxime esters, and combinations thereof.

A combination of Norrish Type I alpha-cleavage and Norrish Type II hydrogen-abstraction PI's, and an amine synergist, are typically used to achieve a balance of rapid surface-curing and bulk through-curing of coated films, combined with non-yellowing, low-odor, low-extractables and other desirable properties for conversion and end-use.

The energy curable coating composition of the invention comprises about 1 wt % to about 20 wt % of one or more photoinitiators, comprising Norrish Type I photoinitiators and Norrish Type II photoinitiators, based on the total weight of the composition, such as about 1 wt % to about 20 wt %, about 1.5 wt % to about 15 wt %, about 2 wt % to about 10 wt %, about 3 wt % to about 5 wt %, about 2 wt % 1 to about 15 wt %, about 3 wt % to about 20 wt %, about 1 wt % to about 15 wt %, about 1 wt % to about 10 wt %, about 1 wt % to about 5 wt %, or about 1 wt % to about 3 wt %.

In some embodiments, one or more photoinitiators are selected from the group consisting of oligomeric compounds, polymeric compounds, acrylated compounds and mixtures thereof.

### Norrish Type I

Norrish Type I photoinitiators include α-hydroxyketones, α-dialkoxy-acetophenones, α-hydroxy-alkyl-phenones, acyl phosphine oxides, α-aminoketones, α-amino-alkyl-phenones, benzoin ethers, benzil ketals, and oxime esters.

Suitable Norrish Type I photoinitiators include, but are not limited to, the following:
α-hydroxyketones such as; 1-hydroxy-cyclohexyl-phenyl-ketone; 2-hydroxy-2-methyl-1-phenyl-1-propanone; 2-hydroxy-2-methyl-4′-tert-butyl-propiophenone; 2-hydroxy-4′-(2-hydroxyethoxy)-2-methyl-propiophenone; 2-hydroxy-4′-(2-hydroxypropoxy)-2-methyl-propiophenone; oligo 2-hydroxy-2-methyl-1-[4-(1-methyl-vinyl)phenyl]propanone; bis[4-(2-hydroxy-2-methylpropionyl)phenyl]methane; 2-hydroxy-1-[1-[4-(2-hydroxy-2-methylpropanoyl)phenyl]-1,3,3-trimethylindan-5-yl]-2-methylpropan-1-one and 2-Hydroxy-1-[4-[4-(2-hydroxy-2-methylpropanoyl)-phenoxy]phenyl]-2-methylpropan-1-one;
acylphosphine oxides, such as 2,4,6-trimethylbenzoyl-diphenylphosphine oxide; ethyl (2,4,6-trimethylbenzoyl)phenyl phosphinate; and bis-(2,4,6-trimethylbenzoyl)-phenylphosphine oxide;
α-aminoketones, such as 2-methyl-1-[4-methylthio)phenyl]-2-morpholinopropan-1-one; 2-benzyl-2-dimethylamino-1-(4-morpholinophenyl)-butan-1-one; and 2-dimethylamino-2-(4-methyl-benzyl)-1-(4-morpholin-4-yl-phenyl)-butan-1-one;
oxime esters such as; 1-phenyl-1,2-propanedione-2-(O-ethoxycarbonyl)oxime; [1-(4-phenylsulfanylbenzoyl)heptylideneamino]benzoate, and [1-[9-ethyl-6-(2-methylbenzoyl)13ethylami-3-yl]-ethylideneamino]acetate; and
polymeric photoinitiators, and sensitizers, such as polymeric aminobenzoates (GENOPOL AB-1 (polymeric 4-dimethylainobenzoic acid derivative) or GENOPOL AB-2 (multifunctional aminobenzoate; 1,3-Propanediol, 2-ethyl-2-(hydroxymethyl)-, polymer with oxirane, 4-(dimethylamino)benzoate) from RAHN, Omnipol ASA (poly(ethylene glycol) bis(p-dimethylaminobenzoate or PolyethyleneGlycol(200)di(β-(4(pacetylphenyl)piperazine))-propionate) from IGM or Speedcure 7040 (a mixture of 1,3-di({α-4-(dimethylamino)benzoylpoly[oxy(1-methylethylene)]}oxy)-2,2-bis({α-4-(dimethyl-amino)benzoylpoly[oxy(1-mefhylethylene)]}oxymethyl)propane and {α-4-(dimethylamino)benzoylpoly-(oxyethylene)-poly[oxy(1-methylethylene)]poly(oxyethylene)}4-dimethyl-amino)benzoate) from Lambson, polymeric thioxanthone derivatives (GENOPOL TX-1 or TX-2; 9-Oxo-9H-thioxanthene-carboxylate, esters with branched polyols) from RAHN, Omnipol TX (diester of carboxymethoxy thioxanthone and polytetramethyleneglycol 250) from IGM, or Speedcure 7010 (1,3-di({α-[1-chloro-9-oxo-9H-thioxanthen-4-yl)oxy]acetylpoly[oxy(1-methylethylene)]}oxy)-2,2-bis({α-[1-methylethylene)]}oxymethyl)propane) from Lambson, polymeric aminoalkylphenones such as Omnipol 910 (polyethyleneglycol(200)di(β-4[4-(2-dimethylamino-2-benzyl)butanoylphenyl]-piperazine)propionate from IGM; polymeric benzoyl formate esters such as Omnipol 2712 (polymeric methyl benzoylformate) from IGM; and the polymeric sensitizer Omnipol SZ (polyethylene glycol(200)di(β-(4(p-acetylphenyl)piperazine))propionate) from IGM.

Examples of other suitable photoinitiators include diethoxy acetophenone; benzil; benzil dimethyl ketal; and the like.

In some embodiments, one or more Norrish Type I photoinitiators are selected from the group consisting of 1-[4-(2-Hydroxyethoxyl)-phenyl]-2-hydroxy-2-methylpropanone, Oligo[2-hydroxy-2-methyl-1-[4-(1-methylvinyl)phenyl]-propanone], 2-hydroxy-1-{4-[4-(2-hydroxy-2-methylpropanoyl)phenoxy]phenyl}-2-methylpropan-1-one. Ethyl (2,4,6-trimethylbenzoyl) phenylphosphinate, Bis(2,4,6-trimethylbenzoyl) phenylphosphine oxide, and mixtures thereof.

### Norrish Type II

Norrish Type II photoinitiators include thioxanthones, benzophenones, aminobenzoates, and phenylglyoxylates.

Suitable thioxanthones include, but are not limited to: 2-4-diethylthioxanthone, isopropylthioxanthone, 2-chlorothioxanthone, and 1-chloro-4-propoxythioxanthone; and combinations thereof.

Suitable benzophenones include, but are not limited to: benzophenone, 4-phenylbenzophenone, and 4-methylbenzophenone; methyl-2-benzoylbenzoate; 4-benzoyl-4-methyldiphenyl sulphide; 4-hydroxybenzophenone; 2,4,6-trimethyl benzophenone, 4,4-bis(diethylamino)benzophenone; benzophenone-2-carboxy(tetraethoxy)acrylate; 4-hydroxybenzophenone laurate; 1-[4-[benzoylphenylsulpho]phenyl]-2-methyl-2-(4-methylphenylsulphonyl)propan-1-one; and combinations thereof.

Suitable phenylglyoxylates include, but are not limited to: phenyl glyoxylic acid methyl ester; oxy-phenyl-acetic acid 2-[hydroxyl-ethoxy]-ethyl ester; oxy-phenyl-acetic acid 2-[2-oxo-2-phenyl-acetoxy-ethoxy]-ethyl ester; and combinations thereof.

Polymeric photoinitiators, and sensitizers are also suitable, including for example, polymeric benzophenone derivatives (GENOPOL BP-1([Benzoylbenzoate, esters with branched polyols) or GENOPOL BP-2 (multifunctional benzophenone derivative; Benzoylbenzoate, esters with branched polyols]) from RAHN, Omnipol BP (di-ester of carboxymethoxybenzophenone and polytetramethyleneglycol 250), Omnipol BP2702(Bis(benzophenone-2-carboxylicacid)polyethyleneglycolester) or Omnipol 682(Diester of carboxymethoxybenzophenone and polyethyleneglycol 200) from IGM or Speedcure 7005(a mixture of: 1,3-di({-2-(phenylcarbonyl)benzoylpoly[oxy(1-methylethylene)]}oxy)-2,2-bis({α-2-phenylcarbonyl)-benzoylpoly[oxy(1-methylethylene)]}oxymethyl) propane and {α-2-(phenylcarbonyl)benzoylpoly(oxyethylene)poly[oxy(1-methyl-ethylene)]-poly(oxyethylene)}2-(phenylcarbonyl)benzoate from Lambson).

Other Norrish Type II photoinitiators include camphorquinone, 2-ethylanthraquinone, and 9-fluorenone.

In some embodiments, one or more Norrish Type II photoinitiators are selected from the group consisting of oligomeric benzophenones, polymeric benzophenones, acrylated benzophenone, and derivatives and mixtures thereof.

In some embodiments, one or more Norrish Type II photoinitiators are selected from the group consisting of 4-(4methylphenylthio) benzophenone, di-esters of carboxymethoxy-benzophenone and polytetramethyleneglycol 250, Methyl-o-benzoylbenzoate, and mixtures thereof.

### Additional Photoinitiators

Visible light photoinitiators, such as titanocene radical initiators including titanium-bis(η 5-2,4-cyclopentadien-1-yl)-bis-[2,6-difluoro-3-(1H-pyrrol-1-yl)phenyl] may also be used.

### Amine Synergist

The energy curable coating composition of the invention comprises about 5 wt % to about 20 wt % of one or more amine synergists, based on the total weight of the composition, such as about 5 wt % to about 18 wt %, about 7 wt % to about 15 wt %, about 10 wt % to about 13 wt %, about 5 wt % to about 15 wt %, about 5 wt % 5 to about 10 wt %, about 5 wt % to about 8 wt %, about 10 wt % to about 20 wt %, about 10 wt % to about 13 wt %, about 15 wt % to about 20 wt %, or about 17 wt % to about 20 wt %.

Suitable examples of amine synergist include, but are not limited to aromatic amines, aliphatic amines, aminoacrylates, and amine modified polyether acrylates.

Examples of aromatic amines include 2-(dimethylamino)ethylbenzoate; N-phenyl glycine; benzoic acid, 4-(dimethylamino)-, 1,1′-[(16ethylamino)di-2,1-ethanediyl]ester; and simple alkyl esters of 4-(N,N-dimethylamino)benzoic acid. In some embodiments of the invention, ethyl, amyl, 2-butoxyethyl and 2-ethylhexyl esters of 4-(N,N-dimethylamino)benzoic acid are particularly preferred. Other positional isomers of N,N-dimethylamino)benzoic acid esters are also suitable.

Suitable aliphatic amines include N-methyldiethanolamine, triethanolamine and tri-isopropanolamine.

Suitable aminoacrylates and amine modified polyether acrylates include EBECRYL 80, EBECRYL 81, EBECRYL 83, EBECRYL 85, EBECRYL 880, EBECRYL LEO 10551, EBECRYL LEO 10552, EBECRYL LEO 10553, EBECRYL 7100, EBECRYL P115 and EBECRYL P116 available from ALLNEX; CN501, CN550, CN UVA421, CN3705, CN3715 (Propylidynetrimethanol, ethoxylated, esters with acrylic acid, reaction products with diethylamine), CN3755 (1,6-Hexanediol diacrylate, 2-aminoethanol polymer), CN381 and CN386 (2-Propenoic acid, 1,1′-((1-methyl-1,2-ethanediyl) bis(oxy(methyl-2,1-ethanediyl))) ester, reaction products with diethylamine), all available from Sartomer; GENOMER 5142 (2-propenoic acid, 1,1′-[(1-methyl-1,2-ethanediyl)bis[oxy(methyl-2,1-ethanediyl)]]ester, reaction products with diethylamine), GENOMER 5161 (Propylidynetrimethanol, ethoxylated, esters with acrylic acid, reaction products with diethylamine), GENOMER 5271 and GENOMER 5275 from RAHN; PHOTOMER 4771 (2-Propenoic acid, 1,6-hexanediyl ester, polymer with 2-aminoethanol), PHOTOMER 4967 (2-Propenoic acid, (1-methyl-1,2-ethanediyl) bis[oxy(methyl-2,1-ethanediyl)]ester, reaction products with diethylamine), PHOTOMER 5006 (Propylidynetrimethanol, ethoxylated, esters with acrylic acid, reaction products with diethylamine), PHOTOMER 4775 (2-Propenoic acid, 1,6-hexanediyl ester, polymer with 2-aminoethanol), PHOTOMER 5662, PUREOMER 5850 (mixture of glycerol, propoxylated, esters with acrylic acid and propylidynetrimethanol, ethoxylated, esters with acrylic acid, reaction products with diethylamine), PHOTOMER 5930 (2-Propenoic acid, polymer with 2-aminoethanol, 1,2-ethanediol and 2-ethyl-2-(hydroxymethyl)-1,3-propanediol), and PHOTOMER 4250 (1H-Azepine-1-propanoic acid, hexahydro-, 2,2-bis[[(1-oxo-2-propen-1-yl)oxy]methyl]butyl ester) all available from IGM, LAROMER LR8996 (Propylidynetrimethanol, ethoxylated, esters with acrylic acid, reaction products with 1-Butanamine, N-butyl-), LAROMER LR8869, LAROMER LR8889, LAROMER LR8997, LAROMER PO 83F, LAROMER PO 84F, LAROMER PO 94F (Poly(oxy-1,2-ethanediyl), α-hydro-ω-[(1-oxo-2-propen-1-yl)oxy]-, ether with 2-ethyl-2(hydroxymethyl)-1,3-propanediol), LAROMER PO 9067, LAROMER PO 9103 (2-Propenoic acid, 1,1′-(1,6-hexanediyl) ester, polymer with 2-aminoethanol), LAROMER PO 9106 and LAROMER PO77F, all available from BASF; AGISYN 701, AGISYN 702, AGISYN 703, NeoRad P-81 and NeoRad P-85 ex DSM-AGI.

In some embodiments, one or more amine synergists are selected from the group consisting of co-polymerizable tertiary amines, aminoacrylates, amine modified polyether acrylates, and mixtures thereof.

In some other embodiments, the amine synergists are selected from the group consisting of propylidynetrimethanol, ethoxylated, esters with acrylic acid, reaction products with diethylamine; 1H-azepine-1-propanoic acid, hexahydro-, 2,2-bis[[(1-oxo-2-propen-1-yl)oxy]methyl]butyl ester; and mixtures thereof.

### EC Coating Additives

The radiation curable compositions and inks of this invention may contain the usual additives to modify flow, surface tension, gloss and abrasion resistance of the cured coating or printed ink. These additives include co-polymerizable amines (crosslinking agents), inert, non-curable resins, extenders, surfactants, surface tension modifier, waxes, anti-blocking release agents, levelling agents, wetting agents, slip agents, flow agents, dispersants, de-aerators, stabilizers (e.g., in-can stabilizers), inorganic and organic fillers and blends thereof.

In some embodiments, the preferred additives include fluorocarbon surfactants, silicones and organic polymer surfactants, and inorganic materials such as talc.

These additives are typically used in an amount of from about 0.1 wt % to about 5 wt %, based on the total weight of the composition.

Suitable examples of such additives include the Tegorad product lines (Tegorad are trademarks and are commercially available products of Tego Chemie, Essen, Germany) and the Solsperse product lines (Solsperse are trademarks and are commercially available products of Lubrizol Company).

Examples of suitable co-polymerizable amines (crosslinking agents) include those used above as amine synergists, such as Allnex Ebecryl P115 (adduct of Diethylamine and Tripropylene Glycol Diacrylate), and co-polymerizable tertiary amines; dialkylenetriamines, such as diethylenetriamine and di-hexamethylene-triamine; dialkylene tetraamines; dialkylene pentaamines; and mixtures thereof.

Suitable surfactants, surface tension modifiers, wetting agents, flow agents, levelling agents, and dispersants include phosphoric acid polyester, fluorocarbon surfactants; silicone polyether acrylates such as Evonik Tego® Rad 2250 (radically cross-linkable organomodified siliconeacrylate); and organic polymer surfactants.

Suitable stabilizers include in-can stabilizers, such as mixture of glycerol, propoxylated, esters with acrylic acid, 2,6-di-tert-butyl-p-cresol, tris(N-hydroxy-N-nitrosophenylamin ato-O,O′)aluminium, 4-methoxy phenol; mixture of glycerol, propoxylated, esters with acrylic acid, 4,4′-isopropylidenediphenol, oligomeric reaction products with 1-chloro-2,3-epoxypropane, esters with acrylic acid, 2,6-di-tert-butyl-p-cresol, tris(N-hydroxy-N-nitro sophenylaminato-O,O′)aluminium, 4-methoxy phenol; mixture of ethoxylated trimethylolpropane triacrylate, 4-methoxy phenol, phenothiazine;

Waxes include polypropylene wax, synthetic polyethylene wax alloy, slip and release-control waxes, such as Shamrock LoAngle 5413 (aka S-413; synthetic wax showing multiple peaks ranging from 107 to 142 °C);

Suitable anti-blocking release agents include surface-treated precipitated silica, untreated fumed silica, calcium stearate, such as United Guardian B-122 calcium stearate powder.

Suitable slip agents include primary and secondary fatty acid amides, including erucamide, oleamide, oleyl palmitamide, and mixtures thereof.

Suitable de-aerators and defoamers include organo-modified polysiloxane, such as ICM 1051, ICM I-1042, Foamtrol 110, polydimethylsiloxane, modified polydimethyl siloxanes, such as BYK-373, polyalkyleneoxide modified heptamethyltrisiloxane.

The methods of the invention may use the usual extenders, and inorganic and organic fillers for the coatings, such as clay, talc, calcium carbonate, magnesium carbonate, or silica to adjust gloss, misting and color strength.

The radiation curable coatings of the present invention may contain, inert, non-curable resins having no curable acrylic groups with a weight number average of 1000-30000 Daltons, such as 1000-4000 Daltons. Suitable inert resins include poly(acrylates), poly(ester), poly(urethanes), poly(amides), ketone resins, aldehyde resins, alkyd resins, phenolic resins, phenol-formaldehyde resins, nitrocellulose, vinyl resins, acrylics, epoxy resins, styrenes, urea resins, melamine-formaldehydes, rosin resins, rosin esters, hydrocarbon resins, and mixtures thereof. Such resins may improve pigment wetting, gloss, rheology and/or flexibility.

### Cure Mechanism

The radiation curable compositions of the present invention can be cured by an actinic light source, such as for example UV-light provided by a high-voltage mercury bulb, a medium-voltage mercury bulb, a xenon bulb, a carbon arc lamp, a metal halide bulb, a UV-LED lamp or sunlight. The wavelength of the applied irradiation is typically within a range of 100-500 nm or 250-350 nm.

After being applied to a printed substrate such as a polyolefin packaging or label film on a printing press, the liquid phase coating is cured to a solid dry film by free-radical polymerization initiated by absorption of UV light radiation, subsequent photolytic breakdown of the PI's, and reaction with unsaturated monomers and oligomers.

Ultraviolet radiation comprising ultraviolet A, ultraviolet B and ultraviolet C radiations (Uva+Uvb+Uvc) is typically used. UV energy is advantageously applied within a range of 40-100 mJ/cm², such as for example, 40-80 mJ/cm², 50-100 mJ/cm², 50-75 mJ/cm², or 50-60 mJ/cm².

In addition, the bulb can be appropriately selected according to the absorption spectrum of the radiation curable composition. Moreover, the inks of this invention can be cured under inert conditions, such as under an environment of one or more inert gases like nitrogen or carbon dioxide.

In some embodiments, to enable printing presses to run at high line speeds, the coatings would cure at a low UV lamp energy consumption of 40-100 mJ/cm² (UVₐ+UV_{b}+UV_{c}), or 50-100 mJ/cm², or 50-75 mJ/cm², or 50-60 mJ/cm² from an industry standard medium pressure mercury (Hg) arc lamp (with less than 1,000 hours lifetime use) and reflector housing, measured with an EIT Power Puck II radiometer. Low UV energy dose curing is achieved in combination with low extractable benzene by using the coating compositions of the invention.

### Print Methods

The coatings of the invention can be formulated for printing by any of the methods well-known in the art for curable polymer coatings, such as flexographic, gravure, screen, spray coating, ink jet, lithographic, roll coating, curtain coating, and the like. In some embodiments, flexographic coating is the preferred method. In some embodiments, the coating is applied by flexographic printing at a flexographic press speed ≥about 600 feet per minute (FPM).

### EC Coating Parameters

Like laminate structures, the methods of the invention provide EC coatings having acceptable performance for the parameters listed below in Table 1 at a wide range of gloss/matte effects when applied at a low coat weight while requiring a low UV energy dose for curing, thereby effectively replacing the need for laminated film and label structures.

The coating and methods of the invention increases the ease of recyclability by preventing the need for separating multiple plastic film layers required for lamination structures, whilst contributing a safe level of undesirable by-products in packaging, especially benzene.

The coatings and method of the invention maximizes converting efficiency, economics, and sustainability for the printer converter by enabling conversion at high press speed (e.g. ≥600 FPM) using low levels of UV light curing energy with low applied coat weights and without the need to print and laminate multiple non-recyclable layers to achieve the required gloss, coefficient of friction (CoF), mechanical durability and chemical resistance.

In some embodiments, the weight of cured coating is from about 1 g/m² to about 5 g/m².

In some embodiments, the cured coating exhibits low odor of ≤about 1.

TABLE 1
Performance parameters for coated prints

| Test | Test Method | Passing Result |
|---|---|---|
| 3M Scotch 610 Adhesive | Based on ASTM D3359-08 | No visible |
| Tape Coating-Ink Removal | | ink/coating removal |
| Fingernail Scratch | Back of fingernail wiped ten (10) | No visible |
| Resistance | cycles back-and-forth | ink/coating removal |
| Water Resistance | Tap water droplet applied to coated | No visible |
| | surface for 10 minutes and wiped off | ink/coating removal |
| | with lint-free and static-free absorbent | |
| | paper cloth | |
| Dry Crinkle Resistance | Folded print-face-to-print-face and | <5% visible |
| | crinkled with 20 repeated back-and- | ink/coating area |
| | forth cycle movements between thumb | removal |
| | and forefinger | |
| Ice Water Crinkle | Print immersed for thirty (30) minutes | <5% visible |
| Resistance | in ice-water followed by the same | ink/coating area |
| | method as for Dry Crinkle Resistance | removal |
| Sutherland Rub Resistance | Print-face-to-Bond-paper, 4 LB | No visible |
| | weight, 500 back-and-forth cycles | ink/coating marking |
| Heat Seal Resistance | Print-face-to-Aluminium-foil, 500 °F, | No visible |
| | 1-second, 40 pounds per square inch | ink/coating transfer |
| | (LBS/in²) | to foil |
| Static-CoF | Face-to-back side of prints | 0.20-0.40 |
| Kinetic-CoF | Face-to-back side of prints | 0.15-0.35 |
| Odor | ¹Test Method shown below | ≤1 |

¹Low odor (i.e. ≤1) as defined subjectively by a panel of odor test subjects based on a scale of 0-5, where 0 = no discernible odor; 1 = very slight odor; 2 = slight odor; 3 = moderate odor; 4 = strong odor; and 5 = very strong odor.

Low Undesirable by-Products and Residues

Certain PI's undergo UV induced decomposition to generate greater amounts of benzene than other types which generate less, depending on molecular structure and subsequent breakdown reaction pathways, and that UV-curable formulations can be developed to minimize photolytic benzene generation. This is accomplished by formulating coatings using raw materials having low residual benzene content (see Table 2), capable of UV-cure at low UV energy dose, producing a low level of photolytic benzene generation after UV-cure, and resulting in a coating that when applied and UV-cured on a printed film at typical coat weights used for example in flexographic printing (1.0-4.5 g/m²) have an overall extractable benzene level of ≤0.1 ng/cm² as measured by Shimazdu QP2020 gas chromatograph with mass spectrometer (GC/MS). Thus, in some embodiments, the cured coating has an extractable benzene level of ≤about 0.1 ng/cm².

Advantageously, the coatings obtained by methods of the invention have low residual and photolytic generation of undesirable products, such as benzene. Thus, the converted film or label of the invention has a low level of residual and undesirable by-products generated from the UV-cure reaction, especially benzene, which is restricted in many packaged products such as bottled water. The Maximum Contaminant Level (MCL) of benzene allowed in public drinking water is 0.005 milligrams per litre (mg/L), as set forth by the U.S. Environmental Protection Agency (EPA) and U.S. Food and Drug Administration (FDA).

### Dynamic Surface Tension

Label and packaging films are designed to be print-receptive and produce high quality graphics with good intercoat adhesion of inks and coatings to the film surface. The surface energy of label and packaging films must be high enough to allow printing inks and coatings to transfer from the printing unit to the substrate film and promote rapid wetting, levelling, and interlayer bond formation.

Typical biaxially oriented packaging label films, such as Taghleef Industries' LMW1 white voided polypropylene, have a printable surface treatment level of at least 38 Dyne/cm (ASTM D2578), and often >50 Dyne/cm measured with Jemmco Accu-Flo Dyne pen solutions, and as a result, the print-face-to-print-face coefficient of friction (CoF) is very high >1.0 (ASTM D1894). High CoF films are unsuitable for applications where printed labels and packaging come into direct face-to-face contact in downstream converting processes such as label applicators, bottle filling and packaging lines, where labelled bottles and films must freely slide past each other at high speed with minimal friction and without damage to the surface printed graphics.

In some embodiments, the cured coatings of the invention have a reduced dynamic surface tension of ≤about 38 Dyne/cm², such as ≤32 Dyne/cm² to enhance substrate wetting, flow, and levelling.

In some embodiments, the dynamic surface tension of the coating is reduced to <38 Dyne/cm², or <32 Dyne/cm², using a silicone polyether acrylate such as Evonik Tego® Rad 2250 (radically cross-linkable organomodified siliconeacrylate), or other surface tension modifier.

### Coefficient of Friction (CoF)

When applied over printed labels and films at a coat weight >1.1 g/m² or >1.5 g/m², the coating compositions obtained by methods of the present invention would advantageously exhibit a face-to-face CoF-static of 0-0.5, or 0.1-0.5, or 0.20-0.40; and CoF-kinetic between of 0-05, or 0.1-0.5, or 0.15-0.35, as measured with a TMI Slip and Friction Tester Model 32-07 at a speed of 6 inches/minute, a sweep length of 5 inches, using a 200-gram sled.

In some embodiments, the cured coating exhibits static coefficient of friction (Static-CoF) of ≤about 0.4, such as about 0.20-0.40. In some embodiments, the cured coating exhibits kinetic coefficient of friction (Kinetic-CoF) of ≤about 0.35, such as about 0.15-0.35.

CoF reduction can be achieved, for example, by using a combination of slip and release-control waxes, such as Shamrock LoAngle 5413 (aka S-413; synthetic wax showing multiple peaks ranging from 107 to 142 °C) and anti-blocking release agents such as United Guardian B-122 calcium stearate powder.

### Gloss Level

The desired gloss level of the coating is designed by adjusting the formulation weight percent ratios of resins, polymers, monomers and oligomers having high-gloss properties with a combination of matte-effect resins, polymers, oligomers, and particulate fillers, to achieve the same range of gloss effects as with laminated films. Coated gloss is typically in the range between 50-90 gloss units for a high-gloss coating, depending on the quality of the substrate and the coating application process, and for a low-gloss matte effect typically 10-20 gloss units, such as <10, measured using a BYK-Gardner model 4561 Micro-gloss Meter at 600 (ASTM D523 and D2457). A range of intermediate gloss levels are easily formulated by adjusting the ratio of gloss and matte components in formulations and by adjusting the coating application process conditions.

In some embodiments, the cured coating exhibits low gloss in the range of about 1 to 50, such as about 5-25.

In some other embodiments, the cured coating exhibits high gloss in the range of about 50 to 90.

### EXAMPLES

The invention is further described by the following non-limiting examples which further illustrate the invention, and are not intended, nor should they be interpreted to, limit the scope of the invention.

### Methods

### Measuring Gloss

Gloss was measured using a BYK-Gardner model 4561 Micro-gloss Meter at 600 (ASTM D523 and D2457).

### Measuring Odor

Odor was defined subjectively by a panel of odor test subjects based on a scale of 0-5, where 0=no discernible odor; 1=very slight odor; 2=slight odor; 3=moderate odor; 4=strong odor; and 5=very strong odor. Low odor was determined as ≤1 under this subjective test.

### Determining Benzene Levels

For determining benzene levels, all of the materials tested were prepared in the same manner, irrespective of physical state at room temperature. Each material was mixed prior to sampling to maximize sample homogeneity. Then, approximately one (1) gram of sample was transferred into a tared 20 milliliter screw cap headspace vial. The sample weight was determined and recorded. The sample vial was sealed, and the vial labeled for analysis. The samples were analyzed on a Shimadzu QP2020 gas chromatograph with mass spectrometric detection equipped with a Rtx-5 MS column (30 m×0.25 mm, df=1.0 microns) [Restek Corporation, Bellefonte, PA]. The instrument was also equipped with an AOC-6000 multifunctional autosampler with SPME, heated headspace and liquid injection hands. Each sample was equilibrated at 130 °C for 30 minutes with agitation. A 1000 L volume was removed from the equilibrated sample using the heated gas tight syringe hand and injected into the split/splitless injection port (split mode at 10:1 split ratio) and the analysis initiated. The injection port was maintained at 250 °C.

Elution was facilitated by temperature programming during the analysis. The oven temperature was initially held at 50 °C for 1.5 minutes, then increased at a rate of 10 °C/minute to a temperature of 95 °C. The temperature was then increased at a rate of 25 °C/minute to a final temperature of 280 °C and held for an additional 1.6 minutes. The total analysis time was 15 minutes. The carrier gas was Helium at a linear velocity of 37.0 cm/second. A Shimadzu SMART source was installed and operated in the Electron Impact (EI) mode. The ion source was maintained at 230 °C. The Mass Spectrometer was operated in selected ion monitoring (SIM) mode, collecting responses at 78 m/z from 2.5 to 6.5 minutes.

The instrument response was calibrated in the following manner. A certified solution of benzene was purchased from Ultra Scientific [EPA-1003, Benzene in Methanol, Lot #CP-5617, 5024±25 μg/mL]. The entire content of the ampule (1 mL) was then transferred into a 10 milliliter volumetric flask and diluted to final volume with methanol to make a working calibration stock solution with a nominal concentration of 500 μg/mL. This calibration stock was serially diluted to generate calibration standards of known composition over a range from 0.05 to 50 micrograms/milliliter. The instrumental response of the 78 m/z ion was used for all quantitative measurements. All results were calculated as nanograms on column. The method level of quantitation (LOQ) was determined to be 0.15 nanograms with a limit of detection (MDL) of 0.03 nanograms. The calibration was found to be linear over the calibrated range with an r² value of >0.999. Samples that displayed elevated signals in the retention time window of the benzene standards were reanalyzed using scan mode to generate a searchable mass spectrum. These spectra were matched against the NIST 14 Mass Spectral Library entry for benzene to confirm the identification as benzene.

TABLE 2
Examples of UV-cure coating raw materials
and amounts of detected benzene contaminant

| Material | Benzene ng/g* |
|---|---|
| Pentaerythritol (5EO) tetraacrylate | <1 |
| Propoxylated glycerol triacrylate | <1 |
| Trimethylolpropane triacrylate | <1 |
| Dipentaerythritol pentaacrylate | <1 |
| Tripropyleneglycol diacrylate | <1 |
| Acrylated benzophenone derivative | <1 |
| 1-[4-(2-Hydroxyethoxyl)-phenyl]-2-hydroxy-2- | <1 |
| methylpropanone | |
| Oligo[2-hydroxy-2-methyl-1-[4-(1- | <1 |
| methylvinyl)phenyl]propanone] and pentaerythritol | |
| (5EO) tetraacrylate | |
| Polyester tetraacrylate | 14.7 |
| Amine-modified polyether triacrylate | 23.6 |
| 2,4,6-Trimethylbenzoyldiphenylphosphine oxide | 132 |
| In-can stabilizer(Mixture of Glycerol, propoxylated, | 176 |
| esters with acrylic acid, 2,6-Di-tert-butyl-p-cresol, | |
| Tris(N-hydroxy-N-nitrosophenylaminato- | |
| O,O′)aluminium, 4-Methoxy phenol) | |
| Polyether tetraacrylate | 258 |

*Determination of Trace Benzene by static headspace GCMS of homogeneously prepared samples equilibrated at 130 °C for 30 minutes and using Agilent Ultra Scientific EPA-1003 certified benzene calibration solution, with signal spectra matched and confirmed to the NIST 14 Mass Spectral Library for benzene, [CAS 71-43-2].

TABLE 3
Examples of PI UV-cure photolytic benzene generation and
extraction with increasing UV light curing energy dose:

| | Extractable benzene | |
|---|---|---|
| | ng/cm²** | |
| | 265 | 2385 |
| Material | mJ/cm² | mJ/cm² |
| 2,2-Dimethoxy-2-phenyl acetophenone | 0.224 | 1.032 |
| 1-Hydroxycyclohexyl-phenyl ketone | 0.236 | 0.991 |
| 2-Hydroxy-2-methyl-1-phenyl propanone | 0.272 | 0.751 |
| 2-hydroxy-1-{4-[4-(2-hydroxy-2- | 0.004 | 0.014 |
| methylpropanoyl)phenoxy]phenyl}-2- | | |
| methylpropan-1-one | | |
| Ethyl (2,4,6-trimethylbenzoyl) | 0.004 | 0.170 |
| phenylphosphinate | | |
| Bis(2,4,6-trimethylbenzoyl) | | 0.071 |
| phenylphosphine oxide | | |
| 1-[4-(2-Hydroxyethoxyl)-phenyl]-2- | 0.003 | 0.011 |
| hydroxy-2-methylpropanone | | |
| 4-(4methylphenylthio) benzophenone | 0.004 | 0.298 |
| Methyl-o-benzoylbenzoate | 0.003 | 0.050 |
| Di-ester of carboxymethoxy-benzophenone | 0.004 | 0.138 |
| and polytetramethyleneglycol 250 | | |
| Polymeric benzophenone derivative, | 0.004 | 0.016 |
| Benzoylbenzoate, esters with branched | | |
| polyols | | |
| Acrylated benzophenone derivative | 0.001 | 0.003 |

**2% PI dissolved in 3-ethoxy trimethylolpropane triacrylate, coated using a laboratory Harper QD Flexo Proofing System with a 550 line-per-inch (LPI), 3.04 billion cubic-microns-per-square-inch (BCM/in²) anilox roll and cured on Aluminium foil with increasing energy dose. Table 3 shows the advantage of using lower UV cure energy in terms of generating extractable benzene.

### Example 1. Comparative UV Curable Coating

A comparative UV curable coating, Example 1, was prepared according to the formulation shown in Table 4.

TABLE 4
Comparative Example 1 UV Cure Coating SRS9603
with high benzene extraction level

| Material | Weight % |
|---|---|
| Epoxy diacrylate in isobornyl acrylate | 55 |
| Urea-aldehyde resin | 3.6 |
| In-can stabilizer (Mixture of Glycerol, | 0.3 |
| propoxylated, esters with acrylic acid, 4,4′- | |
| Isopropylidenediphenol, oligomeric reaction | |
| products with 1-chloro-2,3-epoxypropane, | |
| esters with acrylic acid, 2,6-Di-tert-butyl-p- | |
| cresol, Tris(N-hydroxy-N-nitro | |
| sophenylaminato-O,O′)aluminium, 4- | |
| Methoxy phenol) | |
| Isobornyl acrylate | 2 |
| Tripropyleneglycol diacrylate | 1.9 |
| Acryloyl morpholine | 9.3 |
| Cyclic trimethylolpropane formal acrylate | 18.2 |
| Polydimethylsiloxane | 1.4 |
| 2,4,6-Trimethylbenzoyldiphenylphosphine | 3 |
| oxide | |
| 2-Hydroxy-2-methyl-1-phenyl propanone | 4.5 |
| Untreated fumed silica | 0.3 |
| Polyalkyleneoxide modified | 0.5 |
| heptamethyltrisiloxane | |
| Total weight % | 100.0 |

Composition of comparative Example 1 was coated, applied and cured on a commercial UV-flexo and rotary screen narrow-web label printing press running at typical production speed between 50-200 fpm on clear biaxially-oriented polypropylene (BOPP) film, and subsequently analysed for extractable benzene. Note that Comparative Example 1 failed both the extractable benzene and odor tests.

### Example 2. Inventive UV Curable Coating

An inventive UV curable coating, Example 2, was prepared according to the formulation shown in Table 5.

TABLE 5
Inventive Example 2 UV-Cure Coating NLCFV0451004
with low benzene extraction level

| Material | Weight % |
|---|---|
| Pentaerythritol (5EO) tetraacrylate | 52.48 |
| Propoxylated glycerol triacrylate | 18 |
| Dipentaerythritol pentaacrylate | 8 |
| Acrylated amine synergist (Propylidynetrimethanol, | 10 |
| ethoxylated, esters with acrylic acid, reaction products with | |
| diethylamine) | |
| In-can stabilizer (Mixture of Glycerol, propoxylated, esters | 0.2 |
| with acrylic acid, 2,6-Di-tert-butyl-p-cresol, Tris(N- | |
| hydroxy-N-nitrosophenylaminato-O,O′)aluminium, 4- | |
| Methoxy phenol) | |
| Acrylated benzophenone derivative | 10 |
| 1-[4-(2-Hydroxyethoxyl)-phenyl]-2-hydroxy-2- | 1 |
| methylpropanone | |
| Silicone polyether acrylate | 0.3 |
| Organo-modified polysiloxane | 0.02 |
| Total weight % | 100.00 |

Composition of inventive Example 1 was applied and cured on a commercial UV-flexo narrow-web label printing press, running at typical production speed between 400-800 feet-per-minute (fpm) over various UV flexo coloured inks, on 38-micron (μm) thick white voided biaxially-oriented polypropylene (BOPP) film, and subsequently analysed for extractable benzene. Inventive Example 2 exhibited passing results for all of the properties shown in Table 1 as well as having an acceptable level of extractable benzene.

### Example 3. Inventive UV Curable Coating

An inventive UV curable coating, Example 3, was prepared according to the formulation shown in Table 6.

TABLE 6
Inventive Example 3 UV-cure coating NLCFV0451021 with low
benzene extraction level and matte (low-gloss) finish.

| Material | Weight % |
|---|---|
| Pentaerythritol (5EO) tetraacrylate | 34 |
| Propoxylated glycerol triacrylate | 20.7 |
| Tripropyleneglycol diacrylate | 13 |
| Dipentaerythritol pentaacrylate | 1.7 |
| Acrylated amine synergist (Propylidynetrimethanol, | 9 |
| ethoxylated, esters with acrylic acid, reaction products | |
| with diethylamine) | |
| In-can stabilizer (Mixture of Glycerol, propoxylated, | 0.2 |
| esters with acrylic acid, 2,6-Di-tert-butyl-p-cresol, | |
| Tris(N-hydroxy-N-nitrosophenylaminato- | |
| O,O′)aluminium, 4-Methoxy phenol) | |
| Acrylated benzophenone derivative | 8.5 |
| 1-[4-(2-Hydroxyethoxyl)-phenyl]-2-hydroxy-2- | 1 |
| methylpropanone | |
| Silicone polyether acrylate | 0.3 |
| Organo-modified polysiloxane | 0.4 |
| Wetting dispersing additive (phosphoric acid | 1 |
| polyester) | |
| Surface-treated precipitated silica | 8.5 |
| Polypropylene wax | 1.7 |
| Total weight % | 100.0 |

The composition of inventive Example 3 was applied and cured on a commercial UV-flexo narrow-web label printing press running at production speed on biaxially-oriented polypropylene (BOPP) film, and subsequently analysed in a laboratory in triplicate with results averaged. Inventive Example 3 exhibited passing results for all of the properties shown in Table 1 as well as having an acceptable level of extractable benzene. Inventive Example 3 also has reduced gloss due to the addition of matting agents.

### Example 4. Comparative UV Curable Coating

A comparative UV curable coating, Example 4, was prepared according to the formulation shown in Table 7.

TABLE 7
Comparative Example 4 UV-cure Coating RCIFV0481592
with high benzene extraction level and high odor.

| Material | Weight % |
|---|---|
| Pentaerythritol (5EO) tetraacrylate | 8.8 |
| Trimethylolpropane triacrylate | 12.8 |
| Hexanediol diacrylate | 9 |
| Epoxy diacrylate 55%/; Trimethylolpropane | 30 |
| triacrylate 45% | |
| Aliphatic urethane triacrylate | 17 |
| Amine acrylate | 8 |
| Benzophenone | 6 |
| 2,2-Dimethoxy-2-phenyl acetophenone | 0.75 |
| Ethyl (2,4,6-trimethylbenzoyl) | 0.25 |
| phenylphosphinate | |
| Siloxane defoamer | 0.1 |
| In-can stabilizer (Mixture of ethoxylated | 0.3 |
| trimethylolpropane triacrylate, 4-Methoxy | |
| phenol, Phenothiazine) | |
| 1-Hydroxycyclohexyl-phenyl ketone | 0.1 |
| Methyl diethanolamine | 4.5 |
| Modified polydimethyl siloxane | 0.9 |
| Modified siloxane | 0.5 |
| Modified siloxane | 1 |
| Total weight % | 100.00 |

The composition of comparative Example 4 coating was applied in a laboratory using a Harper QD Flexo Proofing System with a 300 line-per-inch, 4.8 billion cubic-microns-per-square-inch (BCM/in²) anilox roll and cured on Aluminium foil with 60 mJ/cm² UVa+b+c energy dose. Note that Comparative Example 4 failed both the extractable benzene and odor tests.

### Example 5. Inventive UV Curable Coating

Inventive Example 5 was prepared according to the formulation shown in Table 8.

TABLE 8
Inventive Example 5 UV-cure coating NLEFV0441196
with low benzene extraction level.

| Material | Weight % |
|---|---|
| Pentaerythritol (5EO) tetraacrylate | 44.45 |
| Propoxylated glycerol triacrylate | 13.6 |
| Dipentaerythritol pentaacrylate | 6.75 |
| Acrylated amine synergist (1H-Azepine-1-propanoic acid, | 18 |
| hexahydro-, 2,2-bis[[(1-oxo-2-propen-1-yl)oxy]methyl]butyl | |
| ester) | |
| In-can stabilizer (Mixture of Glycerol, propoxylated, esters | 0.6 |
| with acrylic acid, 2,6-Di-tert-butyl-p-cresol, Tris(N-hydroxy- | |
| N-nitrosophenylaminato-O,O′)aluminium, 4-Methoxy phenol) | |
| Di-ester of carboxymethoxy-benzophenone and | 12 |
| polytetramethyleneglycol 250 | |
| 1-[4-(2-Hydroxyethoxyl)-phenyl]-2-hydroxy-2- | 1.2 |
| methylpropanone | |
| Silicone polyether acrylate | 0.6 |
| Organo-modified polysiloxane | 0.7 |
| Calcium stearate | 2 |
| Synthetic polyethylene wax alloy | 0.1 |
| Total weight % | 100.00 |

Coating applied in a laboratory using a Harper QD Flexo Proofing System with a 300 line-per-inch (LPI), 4.8 billion cubic-microns-per-square-inch (BCM/in²) anilox roll and cured on Aluminium foil with 60 mJ/cm² UVa+b+c energy dose.

Composition of inventive Example 5 exhibited passing results for all of the properties shown in Table 1 as well as having an acceptable level of extractable benzene.

### Test Results of Inventive and Comparative UV Curable Coatings

The gloss, odor, and benzene extraction level of Examples 1 to 5 were measured. The results of these tests are shown in Table 9.

TABLE 9
Test results

| | Comp. | Inv. | Inv. | Comp. | Inv. |
|---|---|---|---|---|---|
| | Ex. 1 | Ex. 2 | Ex. 3 | Ex. 4 | Ex. 5 |
| Gloss at 60° | — | ≥80 | 8-18 | 50-90 | 50-90 |
| Odor | 3-4 | 0-1 | 0-1 | 4-5 | 0-1 |
| CoF-Static | — | — | — | 0.2-0.4 | 0.2-0.4 |
| CoF-Kinetic | — | — | — | 0.15-0.35 | 0.15-0.35 |
| Extractable benzene at | 5.21 | 0.07 | 0.08 | 0.12 | 0.06 |
| a cure dose = 60 mJ/ | | | | | |
| cm² of UVa + UVb + | | | | | |
| UVc (ng/cm²) | | | | | |

The data in Table 9 show that when selected acrylates of the present invention are used in amounts required by the methods of the present invention together with photoinitiators and amine synergist required by methods of the invention, excellent results were obtained for all parameters (See Inventive Examples, 2, 3 and 5). Table 9 also shows that:

Comparative Example 4, which has only ~45 wt % of acrylates selected from pentaerythritol (5EO) tetraacrylate, propoxylated glycerol triacrylate, trimethylolpropane triacrylate, dipentaerythritol pentaacrylate, and tripropyleneglycol diacrylate, based on the total weight of acrylates (excluding acrylate amine synergists and EC additives from total acrylates weight), and only ~35 wt % of the above listed acrylates based on the total weight of the composition had high odor and an extractable benzene level of greater than 0.1 ng/cm².

Comparative Example 1, which has only ~2.2 wt % of acrylates selected from pentaerythritol (5EO) tetraacrylate, propoxylated glycerol triacrylate, trimethylolpropane triacrylate, dipentaerythritol pentaacrylate, and tripropyleneglycol diacrylate, based on the total weight of acrylates (excluding EC additives from total acrylates weight), and only 1.9 wt % of the above listed acrylates based on the total weight of the composition had high odor and very high extractable benzene level of greater than 5.2 ng/cm².
UV-coating formulations like Comparative Examples 1 and 4 containing low-molecular-weight and more volatile photoinitiators such as benzophenone and tertiary amines such as methyl diethanolamine were rated as high Odor.
Materials used in Examples 2, 3, and 5, which are less volatile and have higher molecular weight, such as oligomeric- and polymeric-benzophenone, and acrylated and co-polymerizable tertiary amines, are less likely to result in strong odors, and rate between 0-1 depending on other materials and the combined composition.

The present invention has been described in detail, including various embodiments thereof. However, it will be appreciated that those skilled in the art, upon consideration of the present disclosure, may make modifications and/or improvements on this invention that fall within the scope and spirit of the invention.

1. A method for preparing a monoweb label comprising:
(a) providing a substrate;
(b) depositing an energy curable coating composition onto the substrate, wherein the energy curable coating composition comprises:
i. about 50 wt % to about 99 wt % of one or more acrylates, based on the total weight of the composition, of which at least about 50 wt % of the total weight of acrylates are selected from the group consisting of pentaerythritol (5EO) tetraacrylate, propoxylated glycerol triacrylate, trimethylolpropane triacrylate, dipentaerythritol pentaacrylate, tripropyleneglycol diacrylate and blends thereof;
ii. about 1 wt % to about 20 wt % of one or more photoinitiators, comprising Norrish Type I photoinitiators and Norrish Type II photoinitiators, based on the total weight of the composition; and
iii. about 5 wt % to about 20 wt % of one or more amine synergists, based on the total weight of the composition; and
(c) curing the deposited coating at about 30 to about 100 mJ/cm² of ultraviolet radiation comprising ultraviolet A, ultraviolet B and ultraviolet C radiations,
wherein a multi-layer lamination processing is not required for preparing the label.

2. The method of claim 1, wherein the one or more acrylates are selected from the group consisting of pentaerythritol (5EO) tetraacrylate, propoxylated glycerol triacrylate, trimethylolpropane triacrylate, dipentaerythritol pentaacrylate, tripropyleneglycol diacrylate and blends thereof comprise about 60 wt % to about 99 wt % of the energy curable coating, based on the total weight of the coating.

3. The method of claim 1, wherein one or more photoinitiators are selected from the group consisting of oligomeric compounds, polymeric compounds, acrylated compounds and mixtures thereof.

4. The method of claim 1, wherein one or more Norrish Type II photoinitiators are selected from the group consisting of oligomeric benzophenones, polymeric benzophenones, acrylated benzophenone derivatives and mixtures thereof.

5. The method of claim 1, wherein one or more Norrish Type I photoinitiators are selected from the group consisting of 1-[4-(2-hydroxyethoxyl)-phenyl]-2-hydroxy-2-methylpropanone; oligo[2-hydroxy-2-methyl-1-[4-(1-methylvinyl)phenyl]-propanone]; 2-hydroxy-1-{4-[4-(2-hydroxy-2-methylpropanoyl)phenoxy]phenyl}-2-methylpropan-1-one; ethyl (2,4,6-trimethylbenzoyl) phenylphosphinate; bis(2,4,6-trimethylbenzoyl) phenylphosphine oxide; and mixtures thereof.

6. The method of claim 1, wherein one or more Norrish Type II photoinitiators are selected from the group consisting of 4-(4methylphenylthio) benzophenone, di-esters of carboxymethoxy-benzophenone and polytetramethyleneglycol 250, Methyl-o-benzoylbenzoate, and mixtures thereof.

7. The method of claim 1, wherein one or more amine synergists are selected from the group consisting of co-polymerizable tertiary amines, aminoacrylates, amine modified polyether acrylates, and mixtures thereof.

8. The method of claim 1, wherein the amine synergists are selected from the group consisting of propylidynetrimethanol, ethoxylated, esters with acrylic acid, reaction products with diethylamine; 1H-azepine-1-propanoic acid, hexahydro-, 2,2-bis[[(1-oxo-2-propen-1-yl)oxy]methyl]butyl ester; and mixtures thereof.

9. The method of claim 1, wherein the energy curable coating further comprises additives selected from the group consisting of co-polymerizable amines, inert, non-curable resins, extenders, surfactants, surface tension modifier, waxes, anti-blocking release agents, levelling agents, wetting agents, slip agents, flow agents, dispersants, de-aerators, stabilizers, inorganic and organic fillers, and blends thereof.

10. The method of claim 9, wherein the extenders are selected from the group consisting of clay, talc, calcium carbonate, magnesium carbonate, silica and mixtures thereof.

11. The method of claim 1, wherein the weight of cured coating is from about 1 g/m² to about 5 g/m².

12. The method of claim 1, wherein the substrate is recyclable polyolefin.

13. The method of claim 1, wherein the coating is applied by flexographic printing at a flexographic press speed ≥about 600 feet per minute.

14. The method of claim 1, wherein the cured coating exhibits static coefficient of friction of ≤about 0.4.

15. The method of claim 1, wherein the cured coating exhibits kinetic coefficient of friction of ≤about 0.35.

16. The method of claim 1, wherein the cured coating exhibits low odor of ≤about 1.

17. The method of claim 1, wherein the cured coating exhibits a dynamic surface tension of ≤about 38 Dyne/cm².

18. The method of claim 1, wherein the cured coating exhibits low gloss in the range of about 1 to 50.

19. The method of claim 1, wherein the cured coating exhibits high gloss in the range of about 50 to 90.

20. The method of claim 1, wherein the cured coating has an extractable benzene level of ≤about 0.1 ng/cm².

21. A monoweb label prepared by the method of claim 1.

22. A method of providing a readily recycled label that does not require separation of layers or lamination comprising preparing a monoweb label according to the method of claim 1.
